(19) United States
(12) Patent Application Publication
(10) Pub. No.: US 2004/0036713 A1
(43) Pub. Date: Feb. 26, 2004

(54) System, method, and computer program product in a data processing system for defining a process by graphically guiding an example input through selected processing nodes

(75) Inventors: Virgil A. Albaugh, Austin, TX (US); Messaoud Benantar, Austin, TX (US); Philip Yen-Tang Chang, Austin, TX (US); Hari Haranath Madduri, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/226,921

(22) Filed: Aug. 22, 2002

(51) Int. Cl. G09G 5/00

(52) U.S. Cl. 345/709; 345/809

(57) ABSTRACT

A system, method, and computer program product are disclosed for defining a process within a data processing system. Process nodes are identified within the system. Each one of the process nodes is graphically presented to a user. An example input is generated. The example input is a particular type. The system is then taught how to process the particular type of input by graphically guiding the example input through selected ones of the process nodes. The example input is processed by the selected process nodes as the example input is guided through these selected nodes.

### CROSS-REFERENCE TO RELATED APPLICATIONS

The subject matter of the present invention is related to co-pending U.S. application, attorney docket number AUS920020133US1, Ser. No. ______, titled “System, Method, and Computer Program Product in a Data Processing System for Registering With a Service Utilizing a Graphical Depiction of a Process Definition”, filed on the same date herewith, assigned to the same assignee, and incorporated herein by reference.

### BACKGROUND OF THE INVENTION

1. Technical Field

The present invention relates generally to the field of data processing systems and, more specifically to a system, method, and computer program product in a data processing system for defining a process by graphically guiding an example input through selected processing nodes.

2. Description of Related Art

Systems are known which include a set of processing nodes and a given transaction or work order that must be processed. A user who is experienced with a particular type of process may automate that process for processing the given transaction by defining the process using the processing nodes. In this type of system, a knowledgeable user programs the system to execute a process by defining the process and inputting all required information. This knowledgeable user must know, before programming the system, every node that will be used and all information that is necessary in order to execute the process. The system is told by the knowledgeable user exactly how to execute the process. The user must also be able to program the system by creating a process definition script that is the code that will execute the process.

A problem may arise in such a system, however, because the user may not correctly tell the system how to execute the process. The user may omit required information, and thus the process will not execute properly. Also, the user may not remember all of the necessary steps. Some of the necessary process nodes might be left out. In addition, the user may not correctly create the process definition script.

Therefore, a need exists for a method, system, and computer program product for defining a process by teaching the system how to process a particular type of input by graphically guiding the example input through selected process nodes, where the example input is processed by each node as it is guided through the selected nodes and the system is taught, and further by generating the process definition script to execute the process.

### SUMMARY OF THE INVENTION

A system, method, and computer program product are disclosed for defining a process within a data processing system. Process nodes are identified within the system. Each one of the process nodes is graphically presented to a user. An example input is generated. The example input is a particular type. The system is then taught how to process the particular type of input by graphically guiding the example input through selected ones of the process nodes. The example input is processed by the selected process nodes as the example input is guided through these selected nodes. A process definition script is then automatically created.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation which depicts a data processing system in accordance with the present invention;

FIG. 2 illustrates a block diagram of a computer system which may be utilized as a server computer system in accordance with the present invention;

FIG. 3 depicts a block diagram of a computer system which may be utilized as a client computer system in accordance with the present invention;

FIG. 4 is a pictorial representation of a display screen on which is depicted a graphical representation of process nodes in accordance with the present invention;

FIG. 5 illustrates a high level flow chart which depicts teaching a system how to process a particular type of input by graphically guiding an example input having the particular type through selected ones of the process nodes in accordance with the present invention;

FIG. 6 is a pictorial representation of a display screen on which is illustrated a graphical representation of a first step of a process in accordance with the present invention;

FIG. 7 is a pictorial representation of a display screen on which is depicted a graphical representation of a node prompting a user for additional information in order to process the first step of the process in accordance with the present invention;

FIG. 8 is a pictorial representation of a display screen on which is illustrated a graphical representation of an output of the first step of the process in accordance with the present invention;

FIG. 9 is a pictorial representation of a display screen on which is illustrated a graphical representation of a second step of the process in accordance with the present invention;

FIG. 10 is a pictorial representation of a display screen on which is depicted a graphical representation of a third step in which the node prompts a user for additional information in order to process the third step of the process in accordance with the present invention;

FIG. 11 is a pictorial representation of a display screen on which is illustrated a graphical representation of an output of the third step of the process in accordance with the present invention;

FIG. 12 is a pictorial representation of a display screen on which is illustrated a graphical representation of a fourth step of a process in accordance with the present invention;

FIG. 13 is a pictorial representation of a display screen on which is depicted a graphical representation of a node prompting a user for additional information in order to process the fourth step of the process in accordance with the present invention; and

FIG. 14 is a pictorial representation of a display screen on which is depicted a graphical representation of a process definition in accordance with the present invention.

### DETAILED DESCRIPTION OF THE PREFERRED EMBODIMENT

A preferred embodiment of the present invention and its advantages are better understood by referring to the figures, like numerals being used for like and corresponding parts of the accompanying figures.

The present invention is a system, method, and computer program product for defining a process within a data processing system. Process nodes are identified within the system and graphically presented to a user. An example input of a particular type is generated. The system is then taught how to process the particular type of input as the user graphically guides the example input through selected ones of the process nodes.

Each selected process node actually processes an input to generate an output when the user guides the example input through the selected nodes. The user drags an input to a node which then processes that input in order to generate an output. The user may add to the process definition by graphically dragging the output to another node which will then process that received output. Thus, the output of a previously selected node is used as an input to a subsequently selected node. In this manner, a process definition may be created.

A process definition is created as the example input is interactively guided through selected ones of the process nodes. A user first selects one of the process nodes. For example, the user may drag a graphical representation of the example input to and drop it on a graphical representation of a process node. The process node then processes the input and generates an output. If additional information is needed by the process node, the user is prompted by the process node to enter the information. Any additional information is stored in the process definition and associated with this processing step.

Next, the user may take the output from the process node and continue to process it by dragging a graphical representation of the output to another process node. Again, if additional information is needed, the user is prompted to enter that information which is then stored and associated with this processing step. This second node then processes its input to generate an output. This output can be further processed. The user may continue to add to the process definition by continuing to select nodes by dragging the graphical representation of an input to and dropping it on a processing node. Thus, the example input is processed by the selected process nodes as the example input is guided through these selected nodes.

The selected processing nodes, the order the nodes were selected, and any additional information is tracked and stored as the process definition. This process definition may be used when an input needs to be processed that is of the same type as the example input. A process definition script is then created from the process definition.

The present invention provides a highly interactive approach to process definition. The creator of the process gets immediate feedback on what changes occur in the example input as the example flows through and is processed by each selected node. Thus, the process may be debugged as it is being defined. As an additional benefit, the creator of the process definition need not be as experienced because the process definition script is generated as a result of guiding an example through the nodes.

FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. Network 102 may include permanent connections, such as wire or fiber optic cables, or temporary connections made through telephone connections. The communications network 102 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 104 without departing from the scope of the present invention. Moreover, as used herein, communications include those enabled by wired or wireless technology.

Clients 108, 110, and 112 may be, for example, personal computers, portable computers, mobile or fixed user stations, workstations, network terminals or servers, cellular telephones, kiosks, dumb terminals, personal digital assistants, two-way pagers, smart phones, information appliances, or network computers. For purposes of this application, a network computer is any computer, coupled to a network, which receives a program or other application from another computer coupled to the network.

In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

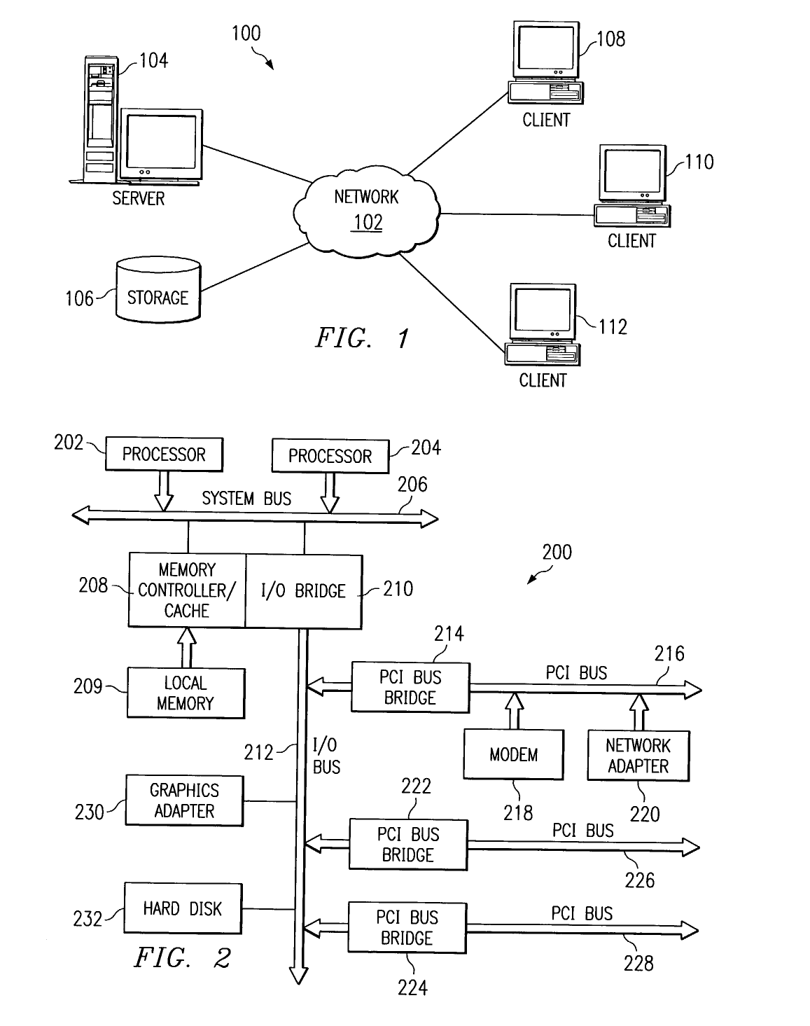

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

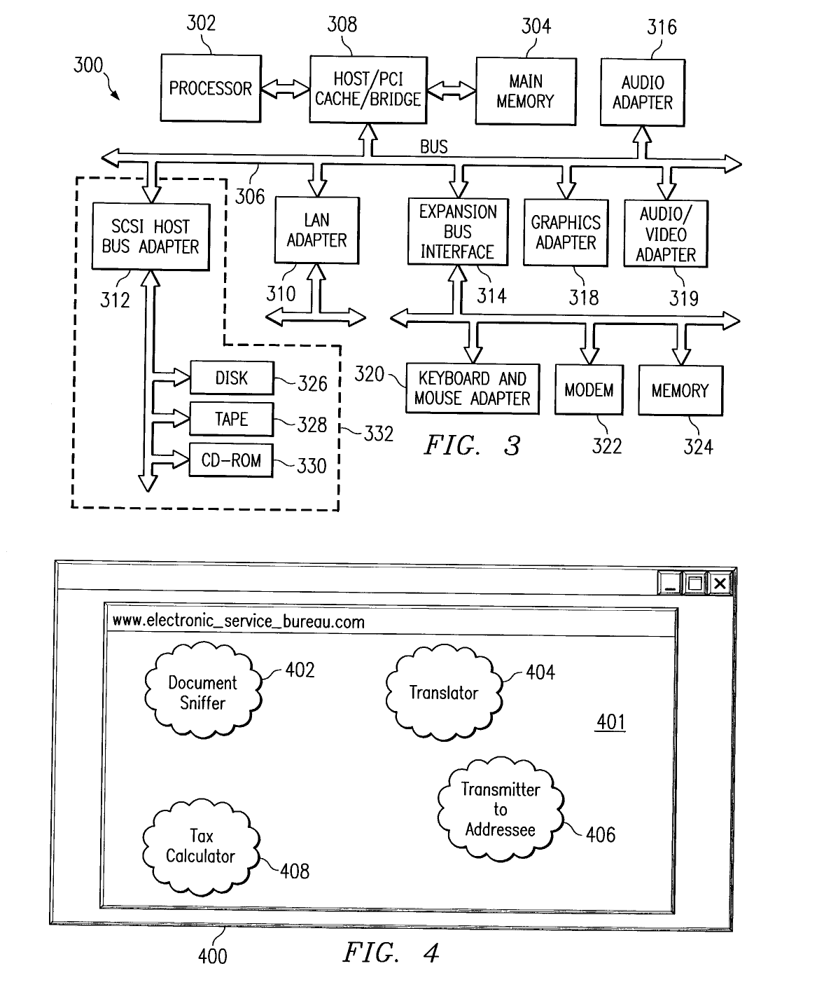

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

FIG. 4 is a pictorial representation of a display screen 400 on which is depicted a graphical representation of process nodes in accordance with the present invention. Process nodes 402, 404, 406, and 408 are graphically depicted to a user utilizing display screen 400. These process nodes may be depicted using an Internet page 401.

Process node 402 is depicted as a document sniffer service. This service receives as its input a document of an unknown type. This service then determines and displays the type of document. Process node 404 is illustrated as a translator service. This service is capable of receiving as its input a document having a first type and translating that document to generate an output where the document now has a second type.

Process node 406 is depicted as a transmitter service whereby documents input to the transmitter service are transmitted to another computer system. Process node 408 is illustrated as a tax calculator service whereby tax is calculated for input transactions.

These various process nodes 402, 404, 406, and 408 together make up an electronic service bureau. The electronic service bureau manages window 401. An electronic service bureau is a centralized collection of services that may or may not be provided by unrelated, different business entities. The services are centralized in that they are presented to a user from a central location, such as through an Internet page. An electronic service bureau may also be called an electronic hub, or ehub. Other process nodes that perform various other types of services may also be included. Further, other process nodes that provide a service that is the same or similar to the depicted process nodes may be included.

One or more of these services may be performed by different computer systems. Further, the services that these nodes represent may be provided by unrelated business organizations. For example, a first business may provide translator node 404 which is executed by that business's computer system which may be located in a particular geographical area. A second business may provide tax calculator node 408 which is executed by the second business's computer system which may be located in a different geographical area. As an example, Business A, located in New York, may provide translator service 404, while Business B, located in California, may provide tax calculator 408. Further, one or more of these nodes may be provided by multiple different computer systems that may be in the same geographical area or in different areas.

Process nodes may receive one input or several different inputs simultaneously. Further, a process node may simultaneously generate more than one output. Thus, a node may receive multiple inputs and generate multiple outputs.

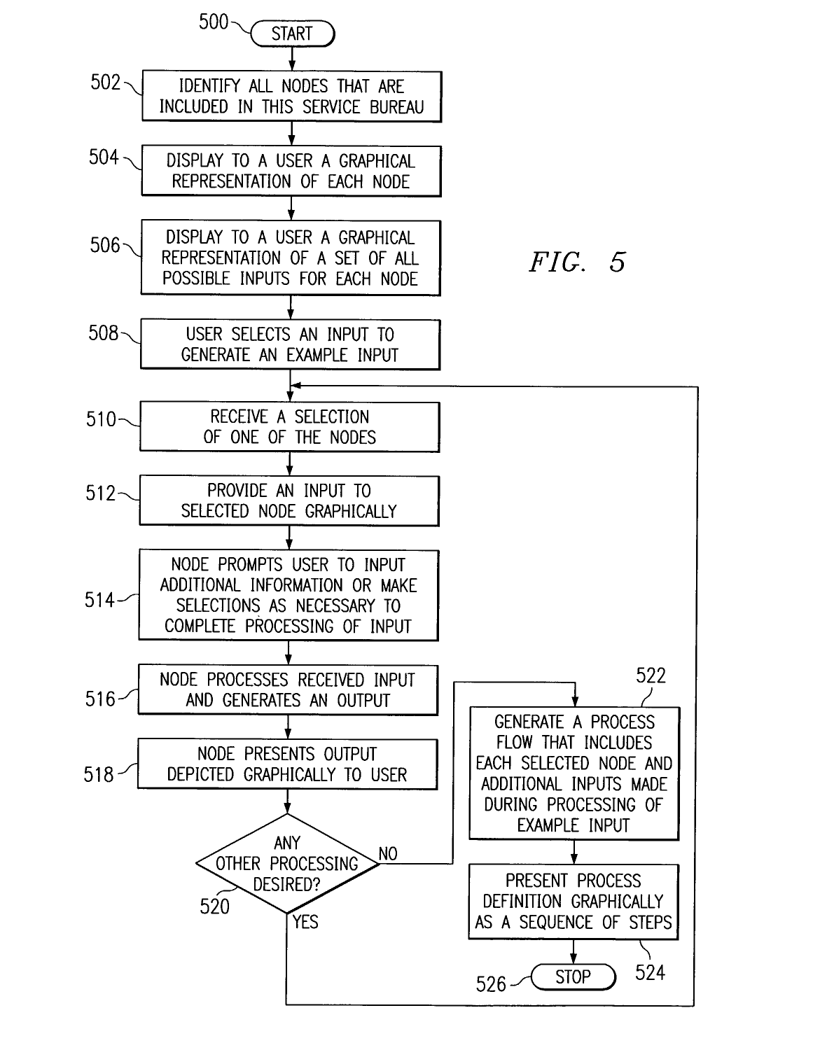

FIG. 5 illustrates a high level flow chart which depicts teaching a system how to process a particular type of input by graphically guiding an example input having the particular type through selected ones of the process nodes in accordance with the present invention. The process starts as depicted by block 500 and thereafter passes to block 502 which illustrates the electronic service bureau identifying all nodes that are included in this service bureau. Next, block 504 depicts the service bureau displaying to a user a graphical representation of each included node. Thereafter, block 506 illustrates displaying to a user a graphical representation of a set of all possible inputs for each node.

Block 508, then, depicts a user selecting one of these inputs in order to generate an example input. The example input has a particular set of characteristics. Thus, when this example input is guided through selected process nodes, the service bureau is being taught how to process an input having these same particular characteristics. A different process must be defined to process inputs that have different characteristics.

Next, block 510 illustrates the service bureau receiving a selection of one of the nodes. This selection may be made in different ways. A selection may be made when a graphical representation of an input is dragged to and then dropped on the graphical representation of the processing node. Or, the processing node may be selected by first selecting the node, such as by double clicking on the graphical representation of the node. Thereafter, block 512 depicts providing an input to the selected node graphically. This input may be the example input, or it may be the output generated by another processing node.

The process then passes to block 514 which illustrates the node prompting a user to input additional information or make selections as necessary in order to complete the processing of the input. Next, block 516 depicts the node processing the received input and any additional information and generating an output. Thereafter, block 518 illustrates the node presenting the output depicted graphically to the user.

Block 520, then, depicts a determination of whether or not further processing is desired. If a determination is made that further processing is desired, the process passes back to block 510. Referring again to block 520, if a determination is made that further processing is not desired, the process passes to block 522 which illustrates generating a process flow definition that identifies each selected node, the order in which the selected nodes were traversed, and any additional inputs that were made during the processing of the example input. In addition, a process script, i.e. the software code that is executable by a computer system, may be generated once the process is defined. Next, block 524 depicts graphically presenting the process definition as a sequence of steps. The process then terminates as illustrated by block 526.

FIG. 6 is a pictorial representation of a display screen on which is illustrated a graphical representation of a first step of a process in accordance with the present invention. Process nodes 602, 604, 606, and 608 are displayed to user via a display screen 600. A process definition is created by first graphically moving an icon 610 that represents a document, “x.doc.unknown”, onto the graphical representation of the document sniffer, icon 602. The document has an unknown type at this point.

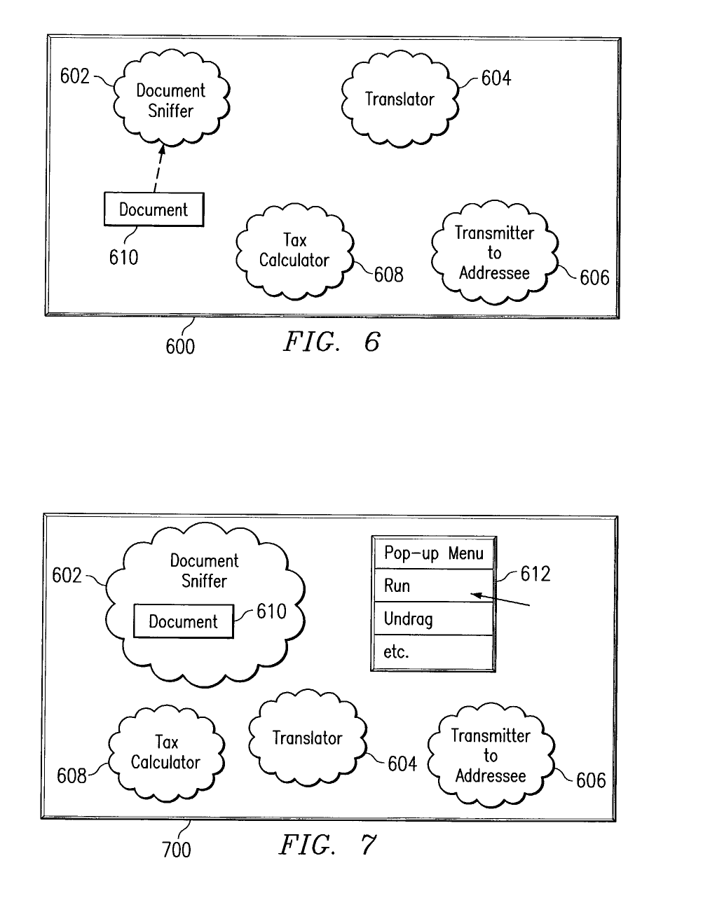

FIG. 7 is a pictorial representation of a display screen on which is depicted a graphical representation of a node prompting a user for additional information in order to process the first step of the process in accordance with the present invention. Once icon 610 has been moved onto icon 602, a pop-up menu 612 is displayed to prompt a user to select an action. As depicted, a “Run” action is selected. Thus, document x.doc.unknown is interrogated by the service depicted by icon 602 to determine its type.

FIG. 8 is a pictorial representation of a display screen on which is illustrated a graphical representation of an output of the first step of the process in accordance with the present invention. Because a user selected a “Run” action, document sniffer 602 determined the type of document x.doc.unknown and generated an output icon 610a which indicates that the document is type EDI. Thus, output icon 610a represents document x.doc.EDI.

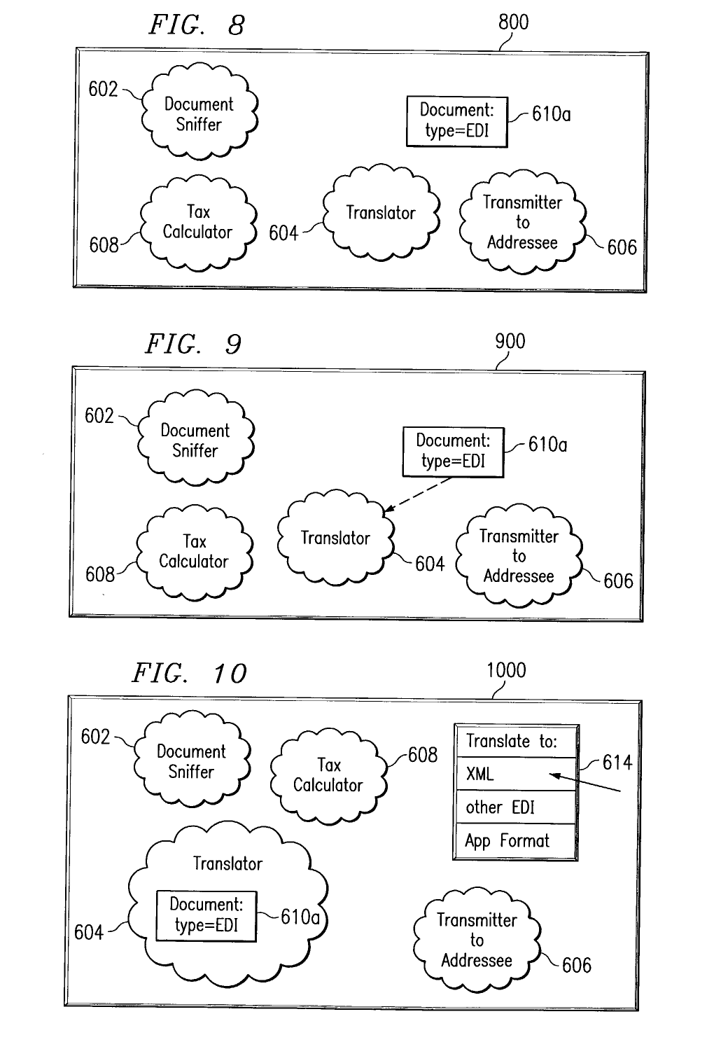

FIG. 9 is a pictorial representation of a display screen on which is illustrated a graphical representation of a second step of the process in accordance with the present invention. The second step of this process is to translate a document having an “EDI” type to a document having an “XML” type. Therefore, output icon 610a is dragged to and dropped onto icon 604 which graphically represents a translator service.

FIG. 10 is a pictorial representation of a display screen on which is depicted a graphical representation of a third step in which the node prompts a user for additional information in order to process the third step of the process in accordance with the present invention. When document x.doc.EDI is input into translator by dragging output icon 610a onto icon 604, a pop-up menu 614 is displayed which prompts a user to select an output type for the translation. As depicted in FIG. 10, a type “XML” has been selected. Thus, document x.doc.EDI will be translated to a document having an XML type.

FIG. 11 is a pictorial representation of a display screen on which is illustrated a graphical representation of an output of the third step of the process in accordance with the present invention. Translator 604 generates an output represented by icon 610b, which represents document x.doc.XML. Document x.doc.EDI was translated by the translator service so that it now is an XML document, x.doc.XML.

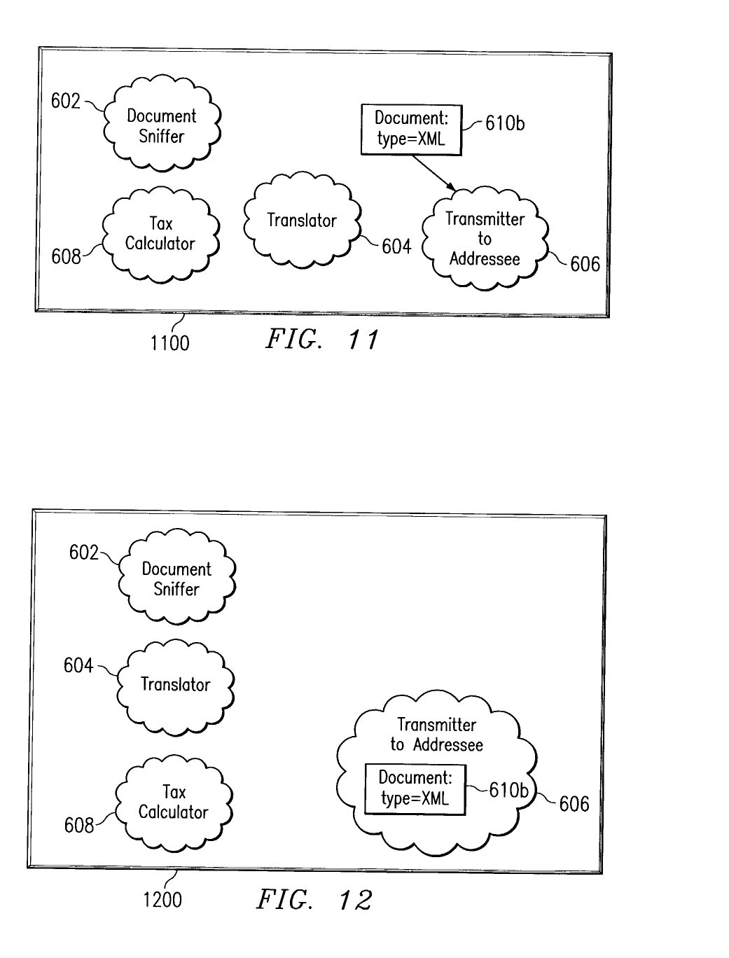

FIG. 12 is a pictorial representation of a display screen on which is illustrated a graphical representation of a fourth step of a process in accordance with the present invention. The graphical representation of the icon 610b is dragged to and dropped onto icon 606 in order to transmit the XML document, x.doc.XML.

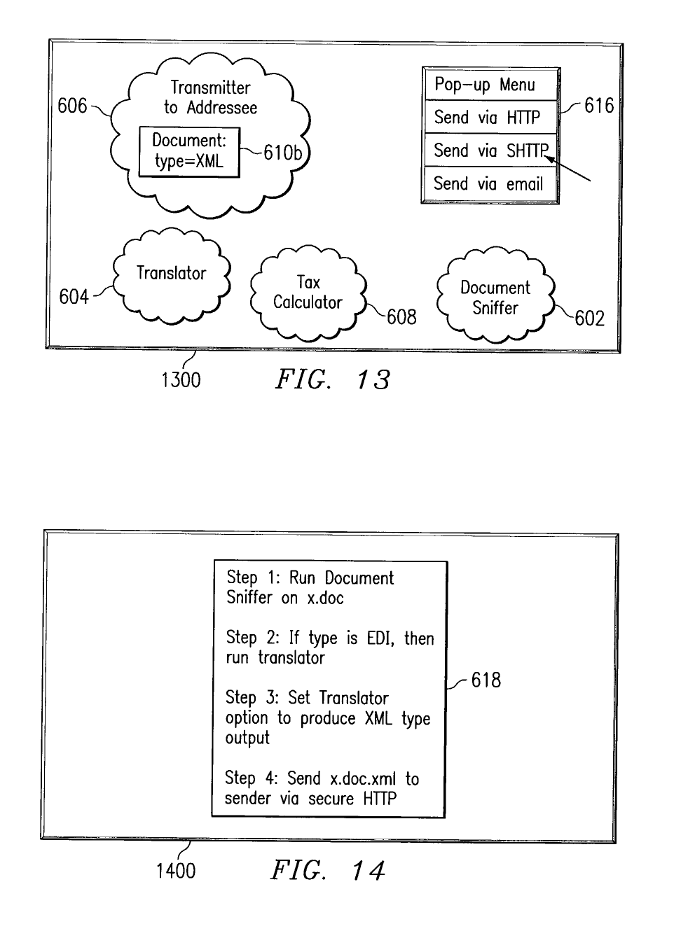

FIG. 13 is a pictorial representation of a display screen on which is depicted a graphical representation of a node prompting a user for additional information in order to process the fourth step of the process in accordance with the present invention. When document x.doc.XML is input into the transmitter service by dragging icon 610b onto icon 606, a pop-up menu 616 is displayed which prompts a user to select a method for transmitting the document. As depicted by FIG. 13, a secure HTTP method has been selected.

FIG. 14 is a pictorial representation of a display screen on which is depicted a graphical representation of a process definition in accordance with the present invention. Process definition 618 was created as the result of the example input being guided through selected process nodes. Further, an executable software script may be generated which will perform this process definition.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for defining a process, said method comprising the steps of:
identifying process nodes within said system;
graphically presenting each one of said process nodes to a user;
generating an example input, said example input being a particular type; and
teaching said system how to process said particular type of input by permitting a user to graphically guide said example input through selected ones of said process nodes, said example input being processed by said selected ones of said process nodes as it is guided through said selected ones of said process nodes.

2. The method according to claim 1, further comprising the step of generating a process definition in response to said example input being guided through said selected ones of said process nodes.

3. The method according to claim 2, further comprising the step of generating a process definition script to execute said process definition.

4. The method according to claim 1, further comprising the steps of:
providing said example input to a first one of said process nodes;
processing said example input by said first one of said process nodes; and
generating a first output in response to said processing said example input by said first one of said process nodes.

5. The method according to claim 4, further comprising the steps of:
providing said first output to a second one of said process nodes;
processing said first output by said second one of said process nodes; and
generating a second output in response to said processing said first output by said second one of said process nodes.

6. The method according to claim 1, further comprising the step of:
prompting a user to enter additional information while said example input is guided through selected ones of said process nodes.

7. The method according to claim 1, further comprising the step of:
processing said example input by said selected ones of said process nodes.

8. The method according to claim 1, further comprising the steps of:
including a service bureau within said system; and
including said processing nodes within said service bureau.

9. The method according to claim 1, further comprising the steps of:
including a plurality of computer systems in said data processing system; and
providing each one of said processing nodes utilizing one of said plurality of computer systems.

10. The method according to claim 9, further comprising the steps of:
including a service bureau within said system; and
including said processing nodes within said service bureau.

11. The method according to claim 1, further comprising the steps of:
including a plurality of computer systems in said data processing system; and
providing each one of said processing nodes utilizing said plurality of computer systems.

12. The method according to claim 1, further comprising the steps of:
selecting ones of said process nodes in order to process said example input;
tracking an order in which said ones of said process nodes are selected; and
generating a process flow definition that includes a listing of said selected ones of said process nodes and said order in which said ones were selected.

13. The method according to claim 12, further comprising the steps of:
prompting a user to enter additional information when said example input is processed by said ones of said process nodes; and
including said additional information in said process flow definition.

14. The method according to claim 1, further comprising each one of said process nodes being capable of receiving multiple simultaneous inputs and generating multiple simultaneous outputs.

15. The method according to claim 1, further comprising the step of providing information to a user about changes to said example input as said example input flows through said selected ones of said process nodes.

16. A data processing system for defining a process, comprising:
process nodes within said system;
each one of said process nodes being graphically presented to a user;
an example input of a particular type; and
said system including a CPU executing code for teaching said system how to process said particular type of input by permitting a user to graphically guide said example input through selected ones of said process nodes, said example input being processed by said selected ones of said process nodes as it is guided through said selected ones of said process nodes.

17. The system according to claim 16, further comprising a process definition being generated in response to said example input being guided through said selected ones of said process nodes.

18. The system according to claim 17, further comprising a process definition script being generated to execute said process definition.

19. The system according to claim 16, further comprising:
said example input being provided to a first one of said process nodes;
said example input being processed by said first one of said process nodes; and
a first output being generated in response to said processing said example input by said first one of said process nodes.

20. The system according to claim 19, further comprising:
said first output being provided to a second one of said process nodes;
said first output being processed by said second one of said process nodes; and
a second output being generated in response to said processing said first output by said second one of said process nodes.

21. The system according to claim 16, further comprising:
said system including a graphical user interface for prompting a user to enter additional information while said example input is guided through selected ones of said process nodes.

22. The system according to claim 16, further comprising:
said example input being processed by said selected ones of said process nodes.

23. The system according to claim 16, further comprising:
a service bureau included within said system; and
said processing nodes being included within said service bureau.

24. The system according to claim 16, further comprising:
a plurality of computer systems included in said data processing system; and
each one of said processing nodes being provided utilizing one of said plurality of computer systems.

25. The system according to claim 24, further comprising:
a service bureau being included within said system; and
said processing nodes being provided by said service bureau.

26. The system according to claim 16, further comprising:
a plurality of computer systems being included in said data processing system; and
each one of said processing nodes being provided utilizing said plurality of computer systems.

27. The system according to claim 16, further comprising:
ones of said process nodes being selected to process said example input;
an order being tracked in which said ones of said process nodes are selected; and
a process flow definition being generated that includes a listing of said selected ones of said process nodes and said order in which said ones were selected.

28. The system according to claim 27, further comprising:
said system including a graphical user interface for prompting a user to enter additional information when said example input is processed by said ones of said process nodes; and
said additional information being included in said process flow definition.

29. The system according to claim 16, further comprising each one of said process nodes being capable of receiving multiple simultaneous inputs and generating multiple simultaneous outputs.

30. The system according to claim 16, further comprising information being provided to a user about changes to said example input as said example input flows through said selected ones of said process nodes.

31. A computer program product in a data processing system for defining a process, said computer program product comprising:
instruction means for identifying process nodes within said system;
instruction means for graphically presenting each one of said process nodes to a user;
instruction means for generating an example input, said example input being a particular type; and
instruction means for teaching said system how to process said particular type of input by permitting a user to graphically guide said example input through selected ones of said process nodes, said example input being processed by said selected ones of said process nodes as it is guided through said selected ones of said process nodes.

32. The product according to claim 31, further comprising instruction means for generating a process definition in response to said example input being guided through said selected ones of said process nodes.

33. The product according to claim 32, further comprising instruction means for generating a process definition script to execute said process definition.

34. The product according to claim 31, further comprising:
instruction means for providing said example input to a first one of said process nodes;
instruction means for processing said example input by said first one of said process nodes; and
instruction means for generating a first output in response to said processing said example input by said first one of said process nodes.

35. The product according to claim 34, further comprising:
instruction means for providing said first output to a second one of said process nodes;
instruction means for processing said first output by said second one of said process nodes; and
instruction means for generating a second output in response to said processing said first output by said second one of said process nodes.

36. The product according to claim 31, further comprising:
instruction means for prompting a user to enter additional information while said example input is guided through selected ones of said process nodes.

37. The product according to claim 31, further comprising:
instruction means for processing said example input by said selected ones of said process nodes.

38. The product according to claim 31, further comprising:
instruction means for including a service bureau within said system; and
instruction means for including said processing nodes within said service bureau.

39. The product according to claim 31, further comprising:
instruction means for including a plurality of computer systems in said data processing system; and
instruction means for providing each one of said processing nodes utilizing one of said plurality of computer systems.

40. The product according to claim 39, further comprising:
instruction means for including a service bureau within said system; and
instruction means for including said processing nodes within said service bureau.

41. The product according to claim 31, further comprising:
instruction means for including a plurality of computer systems in said data processing system; and
instruction means for providing each one of said processing nodes utilizing said plurality of computer systems.

42. The product according to claim 31, further comprising:
instruction means for selecting ones of said process nodes in order to process said example input;
instruction means for tracking an order in which said ones of said process nodes are selected; and
instruction means for generating a process flow definition that includes a listing of said selected ones of said process nodes and said order in which said ones were selected.

43. The product according to claim 42, further comprising:
instruction means for prompting a user to enter additional information when said example input is processed by said ones of said process nodes; and
instruction means for including said additional information in said process flow definition.

44. The product according to claim 41, further comprising each one of said process nodes being capable of receiving multiple simultaneous inputs and generating multiple simultaneous outputs.

45. The product according to claim 41, further comprising instruction means for providing information to a user about changes to said example input as said example input flows through said selected ones of said process nodes.
